(19) United States
(12) Patent Application Publication
(10) Pub. No.: US 2021/0290467 A1
(43) Pub. Date: Sep. 23, 2021

(54) Two Identical Adjustable Graduated Pillows for Surgery and Post-surgery Head Immobilization and Head Positioning

(71) Applicant: Michelle Marie Wilkie, Los Angeles, CA (US)

(72) Inventor: Michelle Marie Wilkie, Los Angeles, CA (US)

(21) Appl. No.: 17/207,006

(22) Filed: Mar. 19, 2021

Related U.S. Application Data
(60) Provisional application No. 62/992,438, filed on Mar. 20, 2020.

(51) Int. Cl. A61G 13/12; A47G 9/10

(52) U.S. Cl. CPC A61G 13/121; A47G 2009/1018; A47G 9/1081

(57) ABSTRACT

Two pillows 12-12 and 112-112 are joined and separated by cords 18 or a strap 118 to enable surgical and post-surgical immobilization and positioning of a user's head or neck. This protects movement of the patient during surgery or thereafter as an aid to the performing surgeon(s) and any post-surgical problems, such as damage or disturbance to stitching.

### CROSS-REFERENCE TO RELATED APPLICATION

This application claims the benefit of U.S. Provisional Application No. 62/992,438 filed 20 Mar. 2020.

### REFERENCE REGARDING FEDERAL SPONSORSHIP OR DEVELOPMENT

Not Applicable

### REFERENCE TO SEQUENCE LISTING OR MICROFICHE APPENDIX

Not Applicable

### BACKGROUND OF THE INVENTION

### 1. Field of the Invention

The present invention relates to head and neck restraint pillows and, in particular, to improvements in such devices that enable surgical head immobilization, post-surgical head immobilization, and sleep-wrinkle prevention head immobilization.

### 2. Description of Related Art and Other Considerations

After surgery of the head and face areas, movement of the head can break open stitches inside and outside the surgery site or displace implants, fat grafting, or cause swelling to pool, causing internal bleeding which can be detrimental to the healing process and produce a poor surgery result. While there are many prior art pillow devices, which are devised to support the head and neck, they lack the necessary immobilization and positioning needed during surgery and thereafter. One group provides a strap over the top of the head or around the forehead; they defeats access during some surgical procedures or could interfere with healing of stitches or overly sensitized nerves as a result from the surgical procedure. For example, these and other patents do not serve the purpose of immobilizing the head and providing access to perform many surgeries such as neurosurgery in which the top of the cranium must be removed, face lift surgery, ear surgery, any surgery of the forehead, etc. Respectively, these same areas must remain unencumbered for protection of stitches and comfort of patient in post-op care. Some pillow devices which use straps around the forehead or the top of the head would prevent a sterile cloth to be placed over the device for optimum surgical sterilization. Some pillow devices employ VELCRO® Brand straps; these tangle hair and is abrasive to the skin.

### SUMMARY OF THE INVENTION

These and other problems are successfully addressed and overcome by the present invention and several advantages are derived therefrom. Such advantages include surgical head immobilization, post-surgical head immobilization, head stabilizing positioning and repositioning, and sleep-wrinkle prevention head immobilization and head-stable positioning, all with minimal surface contact. Accordingly, the head is prevented not only from moving side-to-side during sleep after surgery but also during surgery.

Thus, the device's use is just as much for use in surgical procedures as for post-surgery care sleep comfort. The present invention is set apart from the prior art devices as not just for what it has, but for what it does not have as its streamlined functional design. Its further purpose is to provide the greatest access to one's head, neck and face with the least amount of contact thereto. It is adjustable and capable of being positioned on different places areas of the parietal and the occipital area of the head, of providing a variety of surgical access and likewise post-op isolation of surgical site. Also, the greatest comfort option for the anti-wrinkle sleep purpose is provided. It is created to be a compliment in a multitude of surgeries as well as post-op care. Adjustment is available for different turning angles for surgical access, for post-op care to isolate the traumatized area, and for comfort for stable anti-wrinkle prevention. Improvements include head-turning angle options while still keeping the side of the face from smashing into the pillow. VELCRO® Brand straps are avoided. Pillow devices of the single strap version with no buckle or toggle hold with merely the friction of the material and is usable for surgeries or situations in which quick and easy adjustment must be made instantly. The double strap with a toggle version is meant as a suggestion for the surgeon for surgical procedures in which there is no adjustment needed and the doctor desires to unequivocally eliminate the possibility that the support pillows slide.

Other aims and advantages, as well as a more complete understanding of the present invention, will appear from the following explanation of exemplary embodiments and the accompanying drawings thereof.

### BRIEF DESCRIPTION OF THE DRAWINGS

FIG. 1 is a perspective view of a first embodiment of the present invention shown as a pillow;

FIG. 2 depicts a view of a user's head positioned on the pillow illustrated in FIG. 1;

FIG. 3 is a top view of the pillow depicted in the prior figures in an open position;

FIG. 4 depicts a top view of the pillow depicted in the prior figures in a more closed position than shown in FIG. 3;

FIG. 5 is a bottom view of the present invention as illustrated in the prior figures;

FIG. 6 is a cross-sectional view of the present invention taken along lines 6-6 of FIG. 1;

FIGS. 7 and 8 depict the pillows supporting the user at the back of the user's neck;

FIG. 9-14 depict the pillows supporting the user at the back of the user's head;

FIG. 15 is a perspective view of a second embodiment of the present invention shown as a pillow with a single stray; and

FIG. 16 is a cross-sectional view of the present invention taken along lines 16-16 of FIG. 15.

### DETAILED DESCRIPTION OF THE PREFERRED EMBODIMENTS

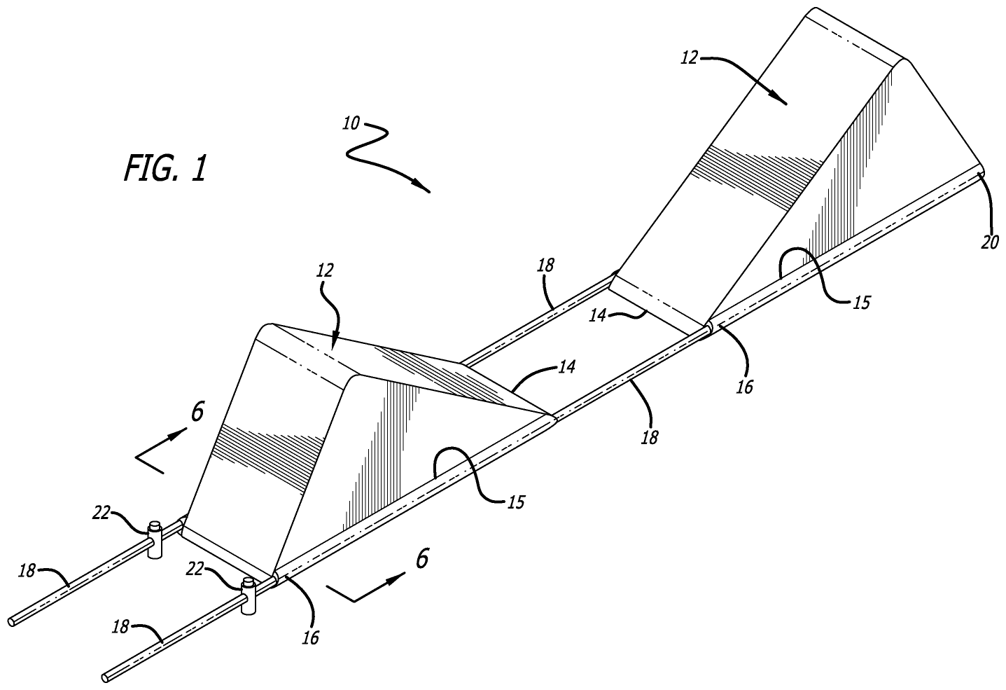

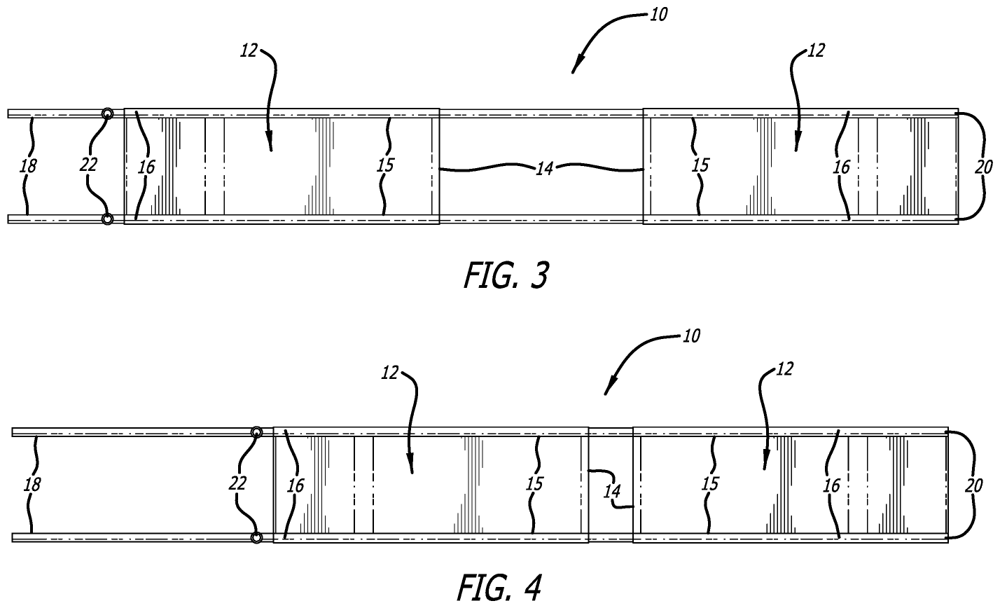

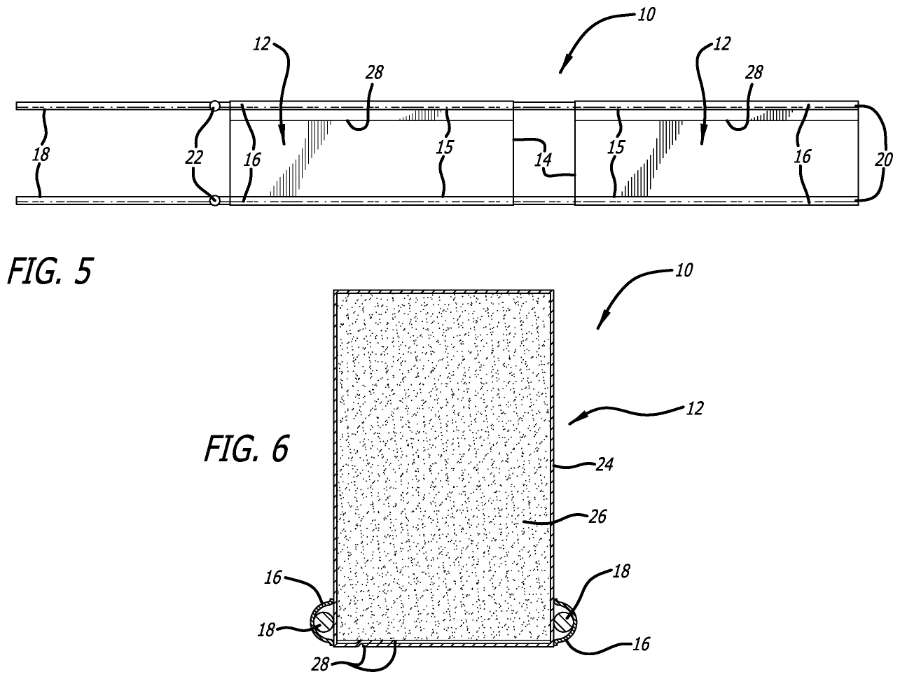

As illustrated in FIGS. 1-6, the present invention as embodied as a pillow attachment mechanism 10 comprises first and second triangular pillows 12 having first and second ends 14 facing one another, first and second sides 15 generally positioned 90 degrees with respect to ends 14, and sleeves 16 which have tunneled configurations and which are secured to sides 15. A pair of first and second cords 18 are inserted within sleeves 16 and extend between and therefrom to enable a variable space to exist between facing ends 14 of pillows 12. Cords 18, e.g., also preferably comprising a micro-fiber, are secured by stitching or any other convenient method to one of the pillow s at fixed ends 20 of the side 12 as appearing at the right side of FIG. 1. At the other pillow 12 as shown at the left side of FIG. 1, a fastener such as a toggle 22 is employed to function to be secured to its cord 18 and, therefore, to limit the space between pillow ends 14.

As best depicted in FIG. 6, each pillow 12 comprises a cover 24 inclosing a foam insert 26. The pillow cover may comprise any suitable material, here as shown as being shown as a cloth, such as comprising a micro-fiber fabric, having overlapping ends 28 which can be opened to enable insertion and removal of the foam insert.

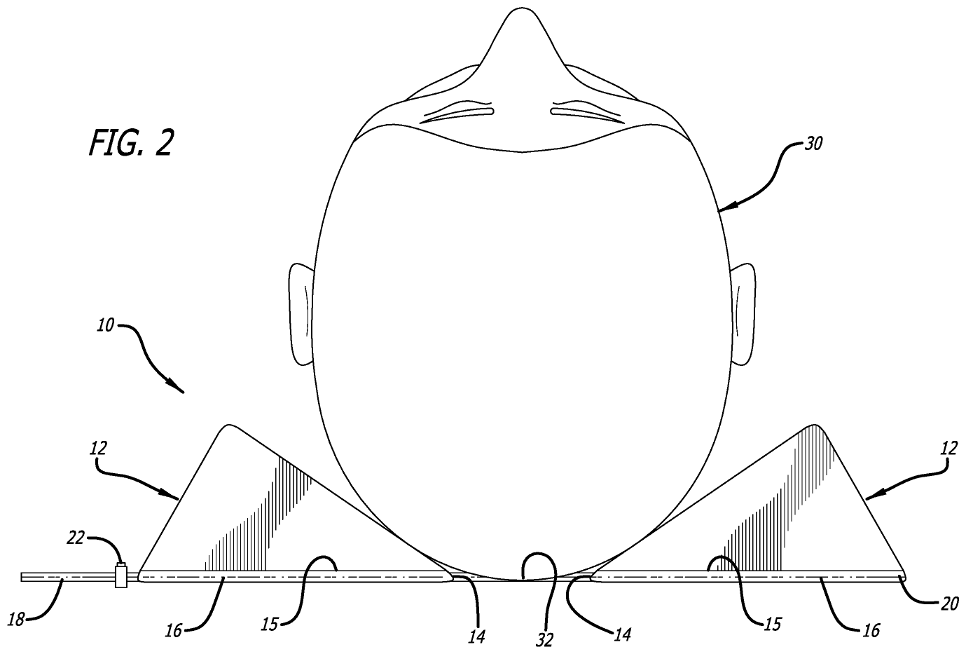

As described earlier and now also shown in FIG. 2, the space between facing ends 14 is determined by the dimension of a user's head 30, as here illustrated, and the user's need (e.g., surgical or post-surgical). Accordingly, the user's head 30 is shown to rest between pillows 12, with the spacing being fixed by use of toggles 22. As stated in the summary of the invention, the device's use is just as much for use in surgical procedures as for post-surgery care sleep comfort.

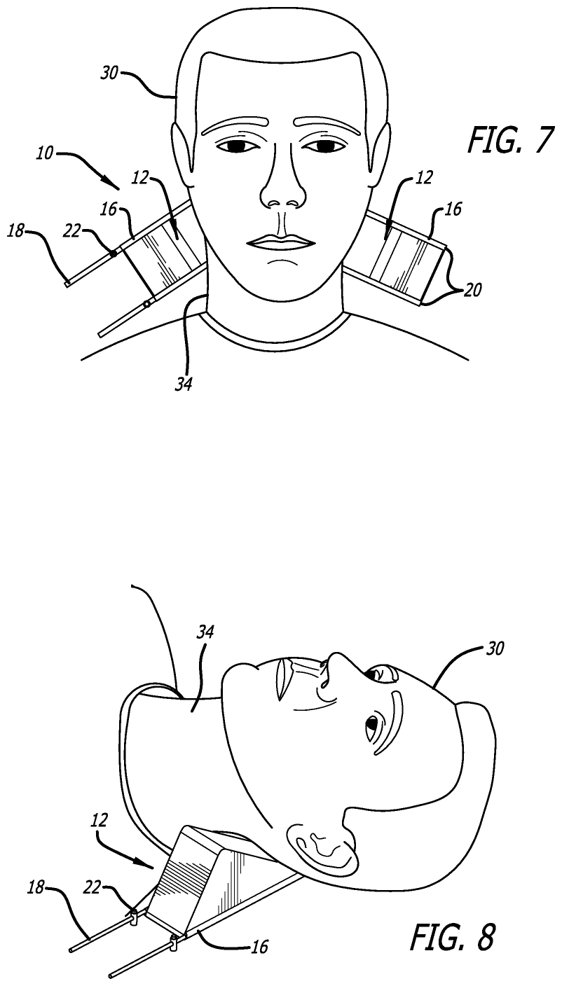

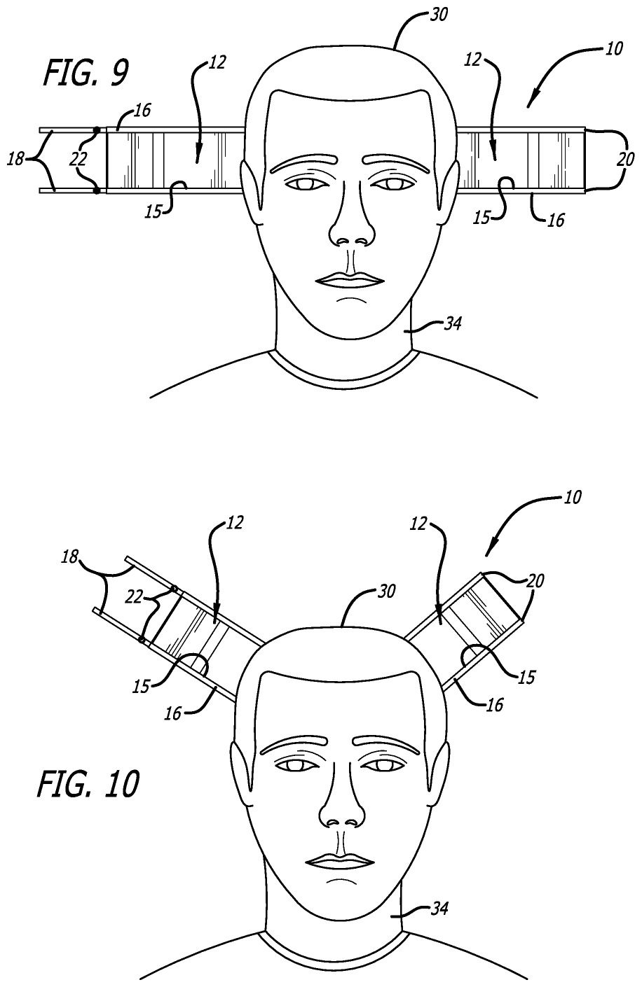

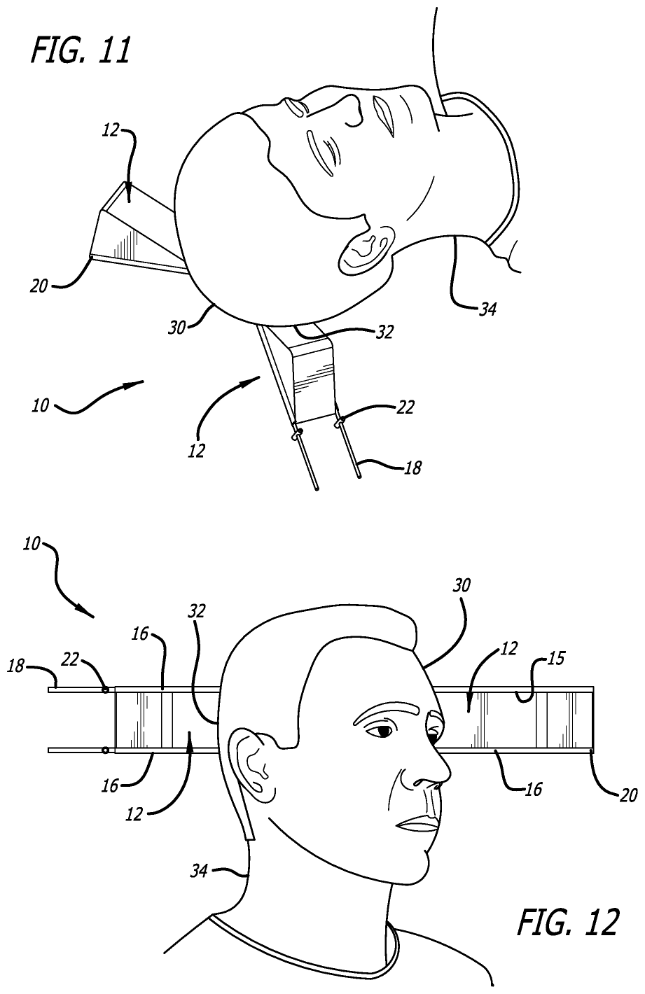

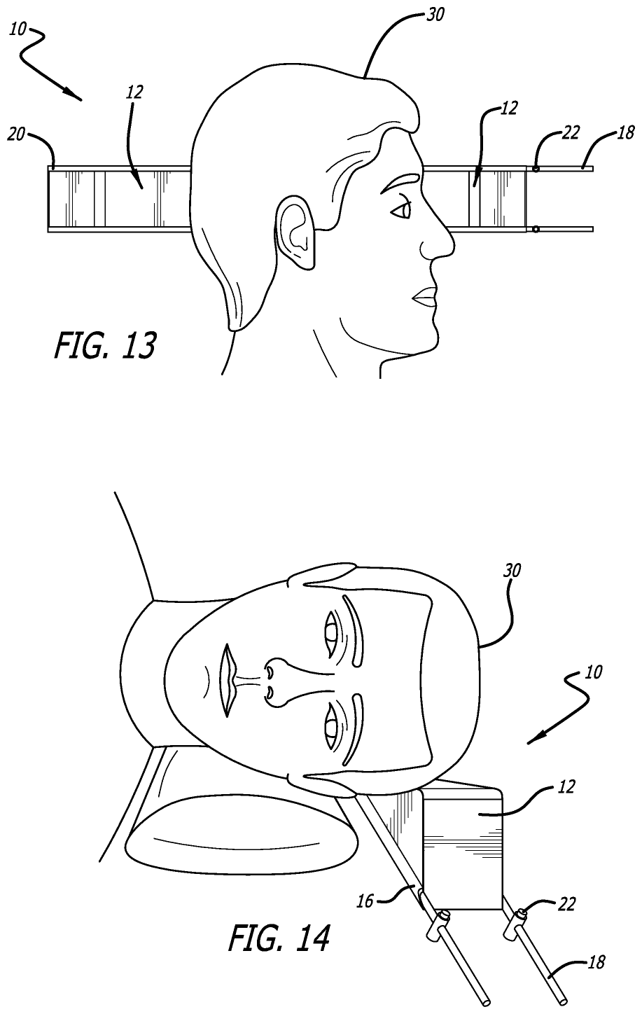

Reference is now made to FIGS. 7-14 which illustrate the use of the first embodiment employing cords 18 and toggles 22, depending on whether support is needed for the user's neck (FIGS. 7 and 8), back of the head (FIGS. 9 and 10) or side of the head (FIGS. 11 and 12).

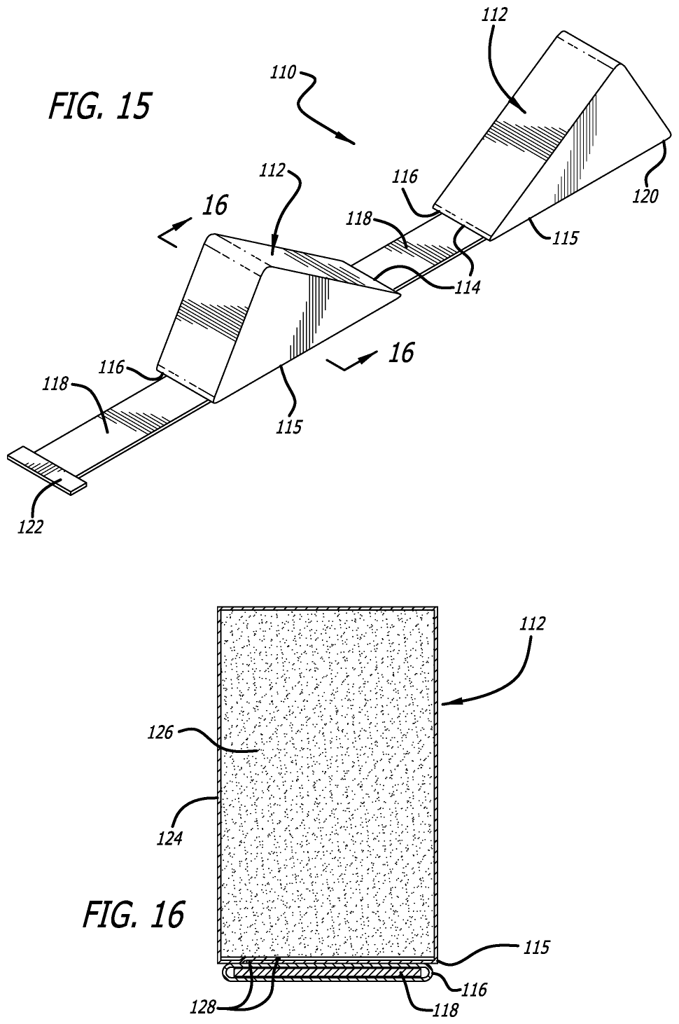

The second embodiment in FIGS. 15 and 16 illustrate a single strap 118 enclosed within sleeves 116 which are placed at the bottom surfaces of pillows 112, which pillows are separated by their facing ends 114. Single strap 118, rather than cords 18 as previously described and shown, acts in a similar manner and, likewise, is secured (as identified by numeral 120) to the pillow as shown in the right side of FIG. 15. A stopper 122 is placed at the end of the strap to ensure that pillow 112, as depicted in the left-hand side of FIG. 15, is retained not to slip from within that sleeve 116 of that left-hand pillow of FIG. 15.

Although the invention has been described with respect to particular embodiments thereof, it should be realized that various changes and modifications may be made therein without departing from the spirit and scope of the invention.

What is claimed is:

1. A pillow attachment mechanism for surgery and post-surgery head use and stable immobilization and positioning of the head and neck comprising:
first and second pillows (a) each having first and second ends facing one another and spaced apart from one another to provide a variable space between said pillows, (b) having third and fourth ends parallelly positioned respectively from said first and second ends, (c) each having parallelly-positioned sides positioned generally 90 degrees from said first and second ends and (d) each having a user head/neck surface;
sleeves (a) each secured to said sides of said first and second pillows and (b) each provided with a generally tunneled configuration;
first and second cords inserted into said pillow sleeves and extending therefrom, with one of each of said cords being secured to the first of said pillows at an end thereof opposite to its facing end and with the other ends of said cords extending from the sleeves of the second of said pillows; and
fasteners secured to said first and second cords at said other ends of said cords extending from the sleeves of the second of said pillows and contacting said ends of said first and second cords which extend from said sleeves of said second pillow, wherein the fasteners, when contacting said second pillow, sets the spacing between said pillow first and second spaced ends for supporting the for the surgery and post-surgery head and mobilization of a user.

2. A pillow attachment mechanism according to claim 1 in which said first and second pillows each comprise a cover and a foam interior placed within said cover, said cover further including a slit for enabling insertion and removal of said foam interior.

3. A pillow attachment mechanism for surgery and post-surgery head use and stable immobilization and positioning of the head and neck comprising:
first and second pillows (a) each having first and second ends facing one another and spaced apart from one another to provide a variable space between said pillows, (b) having third and fourth ends parallelly positioned respectively from said first and second ends, (c) each having parallelly-positioned sides positioned generally 90 degrees from said first and second ends and (d) each having a user head/neck surface;
sleeves (a) each secured to said sides of said first and second pillows and (b) each provided with a generally tunneled configuration;
a strap inserted into said pillow sleeves and extending therefrom, with an end of said strap being secured to the first of said pillows at an end thereof opposite to its facing end and with the other end of said strap extending from the sleeve of the second of said pillows; and
a fastener secured to said strap at said other end thereof and extending from the sleeve of the second of said pillows and contacting said end of said strap which extends from said sleeve of said second pillow, wherein the fasteners, when contacting said second pillow, sets the spacing between said pillow first and second spaced ends for supporting the for the surgery and post-surgery head and mobilization of a user.

4. A pillow attachment mechanism according to claim 3 in which said first and second pillows each comprise a cover and a foam interior placed within said cover, said cover further including a slit for enabling insertion and removal of said foam interior

5. A.

[symbol]

6. A.

[symbol]

7. A.

[symbol]

8. A.

[symbol]

9. A.

[symbol]

10. A. [symbol]
